(19) United States
(12) Patent Application Publication
(10) Pub. No.: US 2004/0150745 A1
(43) Pub. Date: Aug. 5, 2004

(54) Video data transmitting/receiving method

(76) Inventor: Hideki Aiba, Moriya-shi (JP)

Correspondence Address: NATH & ASSOCIATES, PLLC, Sixth Floor, 1030 15th Street, N.W., Washington, DC, 20005, US

(21) Appl. No.: 10/758,120

(22) Filed: Jan. 16, 2004

(30) Foreign Application Priority Data
Jan. 20, 2003 (JP) P2003-011625

(51) Int. Cl. H04N 7/01

(52) U.S. Cl. 348/441

(57) ABSTRACT

A data conversion section of a transmission side allocates 3-channel video data of two pixels constituted of three signals of a 4:4:4 format to data of a 4:2:2 format of three pixels to convert the video data into 2-channel video data. An encoder maps the converted video data in an effective image area defined by the 4:2:2 format, and transmits video data obtained by the mapping through a transmission line. A decoder of a reception side takes out the 2-channel video data from the transmitted video data. A data conversion section allocates the video data of three pixels to data of the 4:4:4 format of two pixels to restore the 3-channel video data constituted of the three signals of the 4:4:4 format.

### BACKGROUND OF THE INVENTION

1. Field of the Invention

This invention relates to a video data transmitting/receiving method for transmitting (transmitting/receiving) video data of a format other than an HDTV signal format through various transmission lines of an HDTV format.

2. Description of the Related Art

At present, STPTE292M standard is in practice as a digital transmission system of HDTV signals. This transmission standard enables transmission of video data of SMPTE274M standard, e.g., video data of 1125 scanning lines (the number of effective lines is 1080, the number of horizontal effective pixels is 1920 dots, a frame frequency is 30/1.001 Hz, and an interlacing operation of 1080/60I system).

Meanwhile, there has been a progress in achievement of higher resolution for image display devices. For example, even an image display device has emerged, which is capable of displaying images at the number of effective pixels set to 2048(horizontal)×1536(vertical) (e.g., Full HDTV Adaptable Superresolution Projector: Journal of Institute of Image Information and Television Engineers Vol. 1.56, No. 8, pp. 1216 to 1218).

However, a format processed in the SMPTE 292M standard is similar to, e.g., that shown in FIG. 1: video data of a standard HDTV signal having a so-called 4:2:2 format including a Y signal of a sampling rate 74.25 MHz (or 74.25/1.001 MHz) and a Pb, Pr signal format of a sampling rate 37.125 MHz (or 37.125/1.001 MHz). Thus, there has been a problem that video data of an RGB 4:4:4 format or video data of a format noncoincident with the number of pixels of the standard HDTV signal, such as graphic images displayed by the projector, cannot be directly transmitted. Incidentally, the transmission of video data other than the aforementioned standard HDTV signal requires a transmission line designed in accordance with a dedicated transmission standard. Thus, there has been a difficulty in constituting a digital transmission line at low costs.

### SUMMARY OF THE INVENTION

An object of the present invention is to provide a video data transmitting/receiving method which enables transmission of video data, even other than a standard HDTV signal, through an existing transmission line of the SMPTE 292M standard or the like.

To realize the above-mentioned object, there is provided: a video data transmitting/receiving method which uses a transmission line for transmitting video data constituted of three signals of a 4:2:2 format, including: allocating 3-channel video data of two pixels constituted of three signals of a 4:4:4 format to data of the 4:2:2 format of three pixels to convert the video data into 2-channel video data, mapping the converted video data in an effective image area defined by the 4:2:2 format, and serializing video data obtained by the mapping to transmit the data through the transmission line, on a transmission side; and taking out the 2-channel video data from the received video data, and allocating the video data of three pixels to data of the 4:4:4 format of two pixels to restore the 3-channel video data constituted of the three signals of the 4:4:4 format on a reception side.

In a preferred embodiment of the present invention, the video data is transmitted through a plurality of transmission lines if the number of horizontal effective pixels of the video data constituted of the three signals of the 4:2:2 format exceeds ⅔ of the number of horizontal effective pixels of the 3-channel video data constituted of the three signals of the 4:4:4 format. The number of transmission lines is set to an integral value obtained by rounding up decimals of a value which is obtained by the following expression: (number of horizontal effective pixels of the video data constituted of the three signals of the 4:4:4 format)÷(number of horizontal effective pixels of the 3-channel video data of the three signals of the 4:2:2 format)×3/2.

Moreover, in order to achieve the aforementioned object, there is provided: a video data transmitting/receiving method which uses a transmission line for transmitting vide data constituted of three signals of a 4:2:2 format, including: allocating 3-channel video data of two pixels constituted of three signals of a 4:4:4 format to data of the 4:2:2 format of three pixels to convert the video data into 2-channel video data, mapping the converted video data in an effective image area defined by the 4:2:2 format in a manner of filling the effective image area with data rows corresponding to scanning lines sequentially from a head address of the effective image area, and serializing video data obtained by the mapping to transmit the data through the transmission line, on a transmission side; and cutting out a data row from the received video data for each predetermined pixel to take out the 2-channel video data, and allocating the video data of three pixels to data of the 4:4:4 format of two pixels to restore the 3-channel video data constituted of the three signals of the 4:4:4 format on a reception side.

In a preferred embodiment of the present invention, the video data is transmitted through a plurality of transmission lines if the number of effective pixels of the video data constituted of the three signals of the 4:4:4 format exceeds ⅔ of the number of effective pixels of the 3-channel video data constituted of the three signals of the 4:2:2 format.

In a preferred embodiment of the present invention, the three signals of the 4:4:4 format and the three signals of the 4:2:2 format are three signals selected from three signals of RGB, three signals of Y, Pr, Pb, and three signals of Y, R-Y, B-Y, respectively.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is an explanatory view showing video data of a 4:2:2 format processed in the SMPTE292M standard;

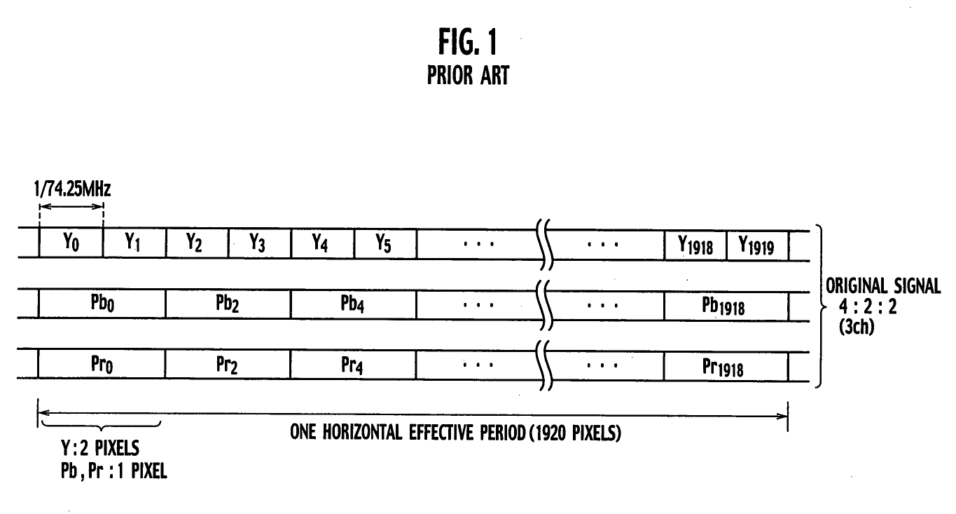

FIG. 2 is a block diagram showing a configuration of a circuit for performing a video data transmitting/receiving method of a first embodiment;

FIG. 3 is an explanatory view showing original video data and converted video data of the first embodiment;

FIG. 4 is an explanatory view showing mapping of the video data of the first embodiment;

FIG. 5 is a block diagram showing a configuration of a circuit for performing a video data transmitting/receiving method of a second embodiment;

FIG. 6 is an explanatory view showing original video data and converted video data of the second embodiment;

FIG. 7 is an explanatory view showing mapping of the video data of the second embodiment;

FIG. 8 is a block diagram showing a configuration of a circuit for performing a video data transmitting/receiving method of a third embodiment;

FIG. 9 is an explanatory view showing mapping of video data of the third embodiment;

FIG. 10 is a block diagram showing a configuration of a circuit for performing a video data transmitting/receiving method of a fourth embodiment;

FIG. 11 is an explanatory view showing original video data and converted video data of the fourth embodiment;

FIG. 12 is an explanatory view showing mapping of the video data of the fourth embodiment; and

FIG. 13 is an explanatory view showing mapping of the video data into which additional data are inserted in the third and fourth embodiments.

### DESCRIPTION OF THE PREFERRED EMBODIMENTS

Herein after, description will be given of embodiments in which a video data transmitting/receiving method of the present invention is applied to video data transmission from a reproducing device (transmission side) such as a VTR to a display device (reception side) such as a projector. Only data transfer portions, which are characteristic in the invention, will be illustrated, and illustration and description for other portions will be omitted.

[First Embodiment]

In a first embodiment, a case in which SMPTE 292M transmission standard is used for transmitting video data, constituted of 1280 horizontal effective pixels and 1024 vertical effective pixels as a graphics format of RGB 4:4:4 and of which a frame frequency is 24 Hz will be described.

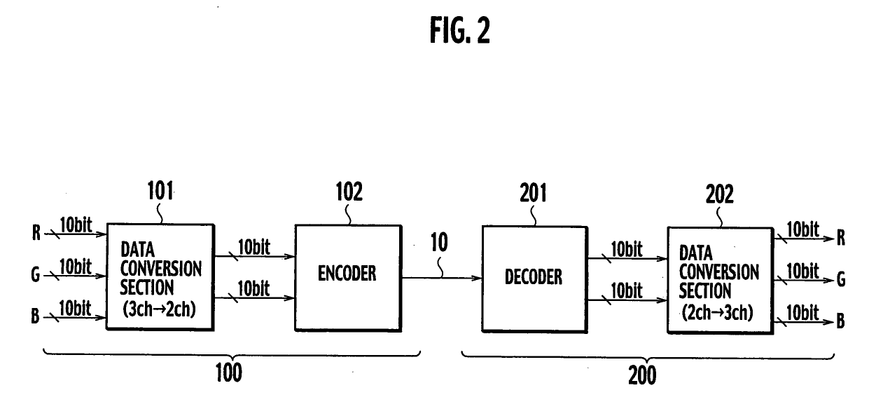

FIG. 2 is a block diagram showing a configuration of a circuit for performing a video data transmitting/receiving method of the first embodiment.

As shown in FIG. 2, a transmission system 100 disposed at an output stage of a transmission side includes a data conversion section 101 and an encoder 102. A reception system 200 disposed at an input stage of a reception side includes a decoder 201 and a data conversion section 202. The encoder 102 and the decoder 201 are connected to each other through a transmission line 10 of the SMPTE292M transmission standard.

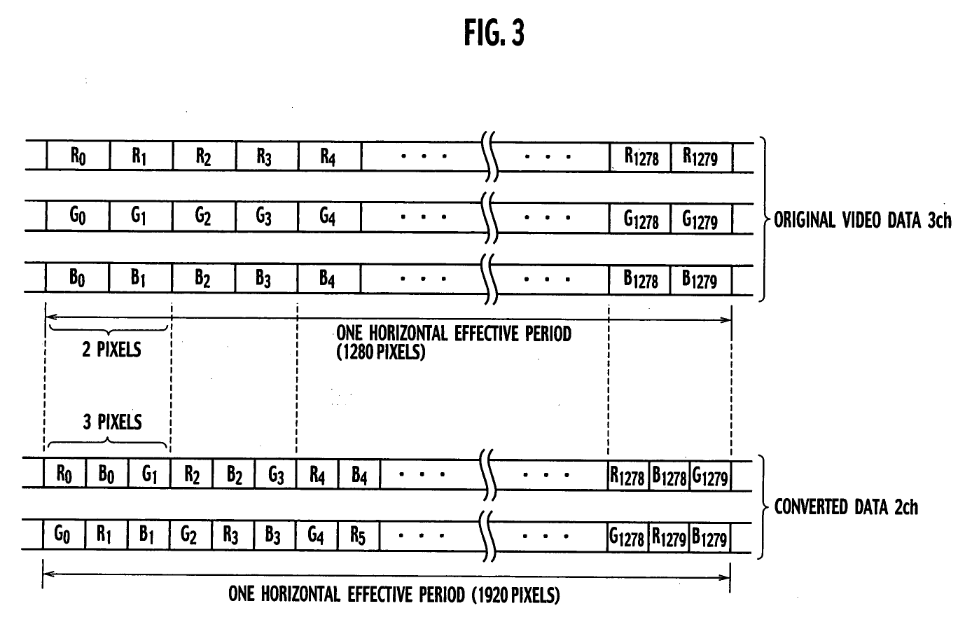

In the transmission system 100, original video data similar to that shown in an upper part of FIG. 3 is inputted to the data conversion section 101. This original video data is 3-channel video data constituted of RGB signals in a 4:4:4 format. Each of the RGB signals is a 10-bit signal. FIG. 3 shows a data row in a given horizontal effective period. The data conversion section 101 allocates the original video data of two pixels to data of a 4:2:2 format of three pixels, which is an existing standard HDTV signal, to convert the video data into 2-channel video data similar to that shown in a lower part of FIG. 3. The original video data has three channels and 1280 pixels (30 bits) in one horizontal effective period, whereas the converted 2-channel video data has two channels and 1920 pixels in one horizontal effective period.

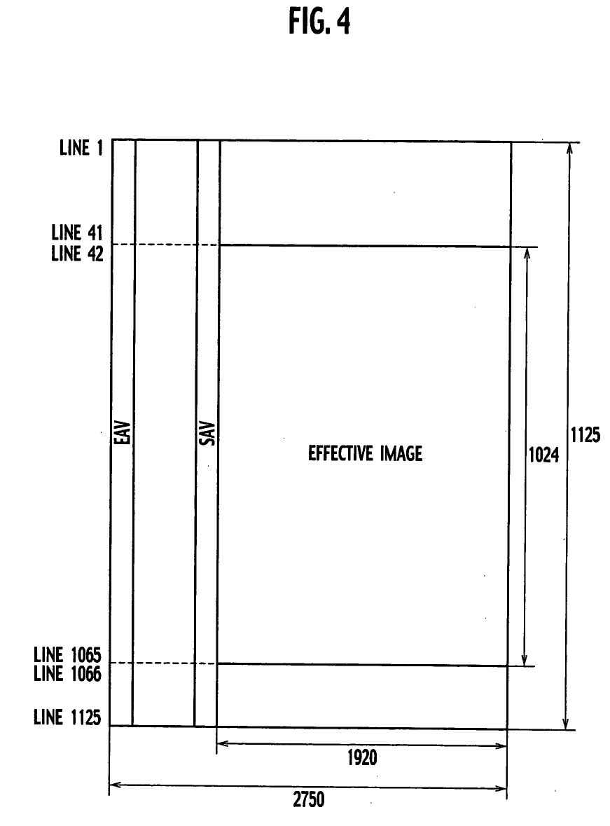

The encoder 102 maps the 2-channel video data in an effective image area of SMPTEM standard similar to that shown in FIG. 4, and adds SAV, EAV codes, a blanking period, and the like, to create transmission video data. Video data of 1920(horizontal)×1024(vertical) occupies a range of horizontal lines 42 to 1066 in an area of 2750(horizontal)×1125(vertical) to be mapped. Accordingly, since the total number of pixels after the mapping becomes 2750(horizontal)×1125(vertical), and the frame frequency is 24 Hz, a sampling frequency becomes equal to 74.25 MHz of a standard HDTV signal. Others are identical to the 1080/24 formation of the SMPTEM standard except for the number of vertical effective pixels. The encoder 102 serializes the transmission video data of 10 bits and two channels to transmit it through the transmission line 10 of the SMPTE292M standard.

In the reception system 200, the original video data is restored in an order reverse to that in the transmission system 100. The decoder 201 first decodes the received video data to be transmission video data of 2×10 bits and two channels, then maps the decoded data in the effective image area of the SMPTEM standard shown in FIG. 4, and removes the SAV, EAV codes, the blanking period and the like, to take the data out as 2-channel video data similar to that shown in the lower part of FIG. 3.

The data conversion section 202 allocates the taken-out video data of three pixels to data of a 4:4:4 format of two pixels to restore the original 3-channel video data of the 4:4:4 format (original video data) similar to that shown in the upper part of FIG. 3.

Thus, according to the first embodiment, even the video data of the RGB 4:4:4 format not corresponding to the format of the standard HDTV signal can be transmitted through the existing transmission line of the SMPTE 292M standard.

[Second Embodiment]

In a second embodiment a case in which a transmission line of SMPTE 292M transmission standard is used for transmitting video data, constituted of 2048 horizontal effective pixels and 1536 vertical effective pixels as a graphics format of RGB 4:4:4 and of which a frame frequency is 24 Hz will be described. In the embodiment, since 2048, which is the number of horizontal effective pixels of video data of an RGB 4:4:4 format, exceeds two-thirds of 1536, the number of horizontal effective pixels of the 4:2:2 transmission line, when the pixels of video data is distributed over the horizontal and vertical effective pixels of the 4:2:2 transmission line, transmission lines of two systems are arranged.

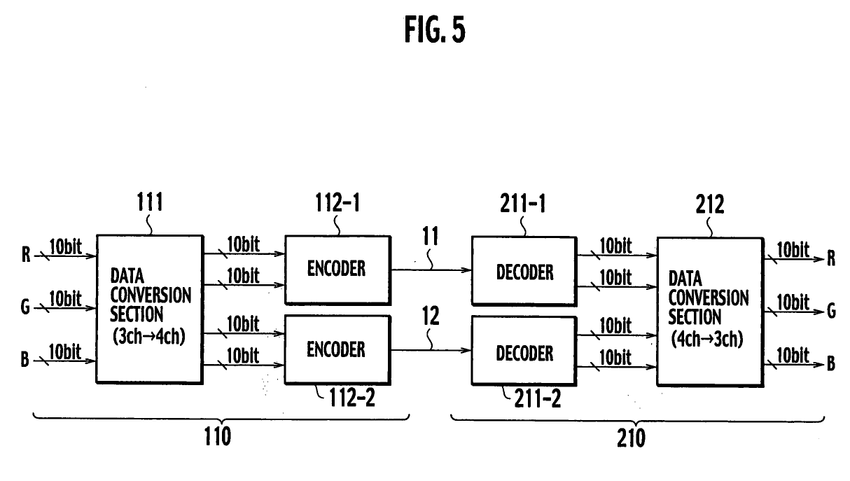

FIG. 5 is a block diagram showing a configuration of a circuit for performing a video data transmitting/receiving method according to the second embodiment.

As shown in FIG. 5, a transmission system 110 disposed at an output stage of a transmission side includes a data conversion section 111 and encoders 112-1 and 112-2. A reception system 210 disposed at an input stage of a reception side includes decoders 211-1 and 211-2, and a data conversion section 212. The encoder 112-1 and the decoder 211-1 are connected to each other through a transmission line 11 of the SMPTE292M transmission standard. The encoder 112-2 and the decoder 211-2 are connected to each other through a transmission line 12 of the SMPTE292M transmission standard.

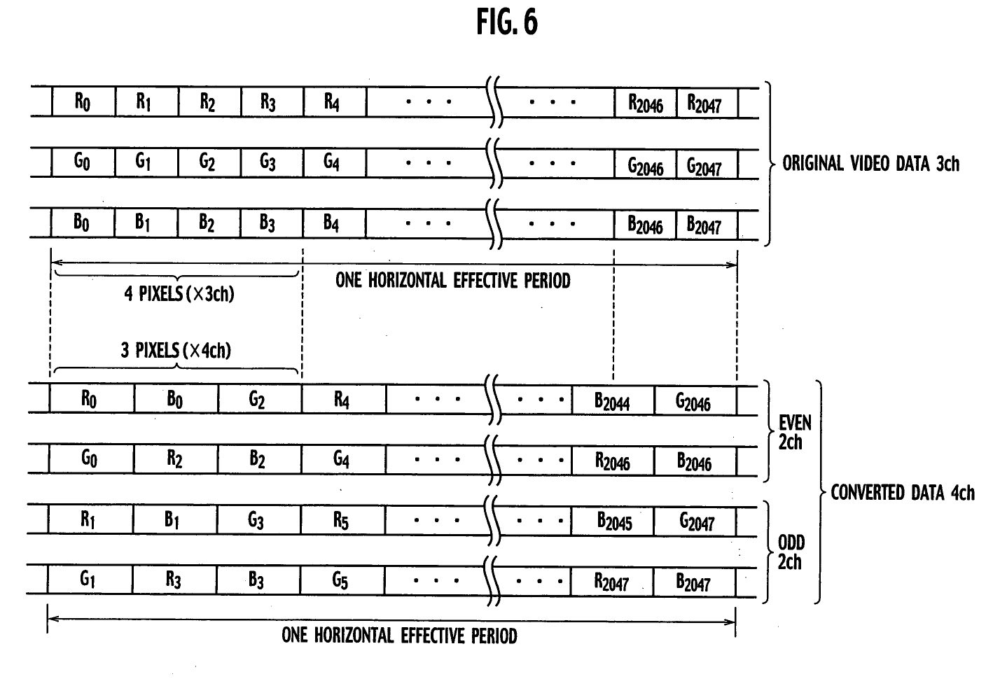

In the transmission system 110, original video data similar to that shown in an upper part of FIG. 6 is inputted to the data conversion section 111. This original video data is 3-channel video data constituted of RGB signals in a 4:4:4 format. Each of the RGB signals is a 10-bit signal. FIG. 6 shows a data row in a given horizontal effective period. The data conversion section 111 allocates the original video data of four pixels to data of a 4:2:2 format of three pixels, which is an existing standard HDTV signal, to convert the video data into 4-channel video data similar to that shown in a lower part of FIG. 6. In this case, pixels contained in the original video data are classified into even pixels R0, R2, R4, . . . , G0, G2, G4, . . . , B0, B2, B4, . . . , and odd pixels R1, R3, R5, . . . , G1, G3, G5, . . . , B1, B3, B5, . . . . These pixels are allocated to two channels (two channels for even pixels, two channels for odd pixels) to constitute 4-channel video data. That is, the data of four pixels contained in the original data are allocated to data of the 4:2:2 format of three pixels by allocating the 4-pixel data of two pixels to one channel of three pixels. Thus, the 3-channel video data of 2048 horizontal effective pixels in the RGB 4:4:4 format is converted into the 4-channel video data of 1536 horizontal effective pixels.

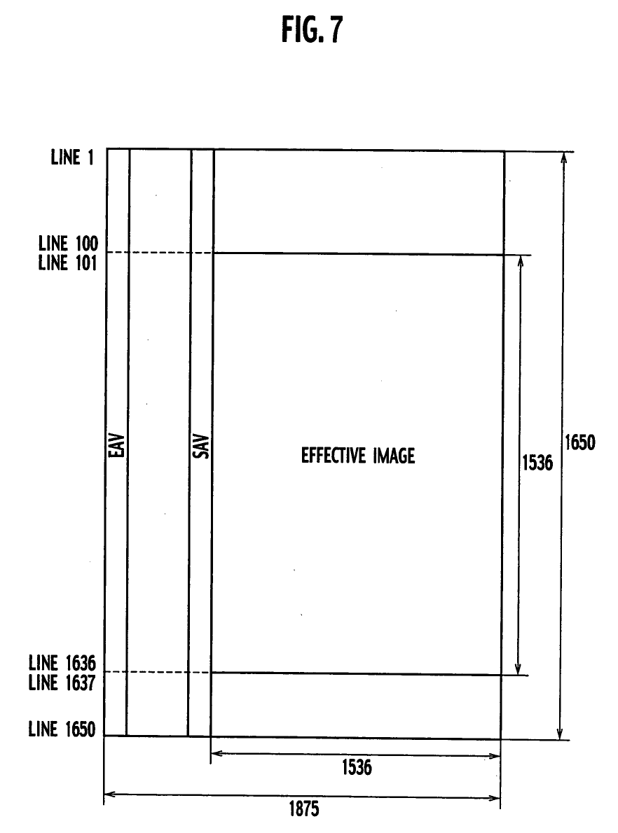

The encoders 112-1 and 112-2 combine the 4-channel video data shown in the lower part of FIG. 6 for every two channels to map the video data in an effective image area of SMPTE standard, and add SAV, EAV codes, a blanking period and the like, to create transmission video data. In this case, there are no standard signals in SMPTE 274M standard to satisfy 1536, which is the number of vertical effective pixels. However, if the total number of pixels for the transmission video data is set to 1875(horizontal)×1650(vertical) {or 1650(horizontal)×1875(vertical)}, and the number of effective pixels is set to 1536(horizontal)×1536(vertical) as shown in FIG. 7, a sampling frequency becomes 74.25 MHz to enable use of the encoder and the decoder of the SMPTE292M. The encoders 112-1 and 112-2 serialize the transmission video data of 2×10 bits and two channels to transmit the data through the respective transmission lines 11 and 12 of the SMPTE292M standard.

In the reception system 210, the original video data is restored in an order reverse to that in the transmission system 110. The decoders 211-1 and 211-2 first decode the received video data to be transmission video data of 2×10 bits and two channels, then map the decoded data in the effective image area of the SMPTEM standard shown in FIG. 7, and remove the SAV, EAV codes, the blanking period and the like, to take the data out as video data of 10 bits and 4-channel similar to that shown in the lower part of FIG. 6.

The data conversion section 212 allocates the taken-out video data of three pixels to data of a 4:4:4 format of four pixels to restore the original 10-bit and 3-channel video data of the 4:4:4 format (original video data) similar to that shown in the upper part of FIG. 6.

Thus, according to the second embodiment, even the video data of the number of effective pixels set to 2048(horizontal)×1536(vertical) can be transmitted through the existing transmission lines of the two systems of the SMPTE 292M standard.

[Third Embodiment]

In a third embodiment, a case in which a transmission line of SMPTE 292M transmission standard is used for transmitting video data, constituted of 2048 horizontal effective pixels and 1536 vertical effective pixels and of which a frame frequency is 24 Hz, as a graphics format of RGB 4:4:4 will be described. In the embodiment, transmission lines of two systems are arranged as in the case of the second embodiment.

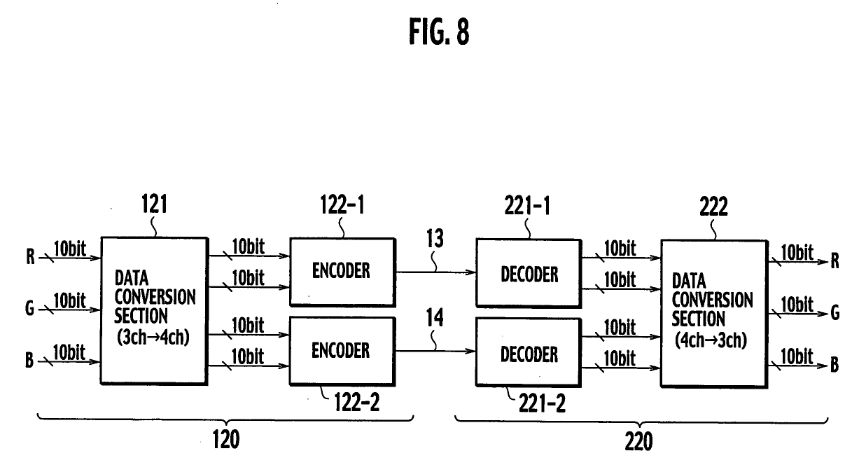

FIG. 8 is a block diagram showing a configuration of a circuit for performing a video data transmitting/receiving method of the third embodiment.

As shown in FIG. 8, a transmission system 120 disposed at an output stage of a transmission side includes a data conversion section 121 and encoders 122-1 and 122-2. A reception system 220 disposed at an input stage of a reception side includes decoders 221-1 and 221-2, and a data conversion section 222. The encoder 122-1 and the decoder 221-1 are connected to each other through a transmission line 13 of the SMPTE 292M transmission standard. The encoder 122-2 and the decoder 221-2 are connected to each other through a transmission line 14 of the SMPTE292M transmission standard.

In the transmission system 120, original video data similar to that shown in an upper part of FIG. 6 is inputted to the data conversion section 121 same as in the case of the second embodiment. This original video data is 3-channel video data constituted of RGB signals of 10 bits in a 4:4:4 format. The data conversion section 121 allocates the original video data of four pixels to data of a 4:2:2 format of three pixels, which is an existing standard HDTV signal, to convert the original video data into 4-channel video data similar to that shown in a lower part of FIG. 6. Thus, the 3-channel video data of 2048 horizontal effective pixels in the RGB 4:4:4 format is converted into the 4-channel video data of 1536 horizontal effective pixels.

If this video data is serialized to be transmitted, it becomes 1536(horizontal)×1536(vertical)×24(Hz)×10(bits)×4(channels)=about 2.265 Gbps. Thus, in order to serialize and transmit the video data at a transmission speed of 1.485 Gbps equal to that of the SMPTE292M standard, the 4 channels are divided into two channels, and the video data is transmitted through the two transmission lines 13 and 14. However, the number of effective pixels which is 1536(horizontal)×1536(vertical) is larger than 1920×1080 defined for a standard HDTV signal (i.e., 1080×24p) of a frame frequency 24 Hz in the SMPTE274M. If a blanking period is used, however, the number of effective samples can be allocated. According to the SMPTE292M, since signals of Y and C, each 10 bits, of two channels can be transmitted, the number of effective pixels which is 1536(horizontal)×1536(vertical) can be transmitted if there are two systems of SMPTE292M transmission lines.

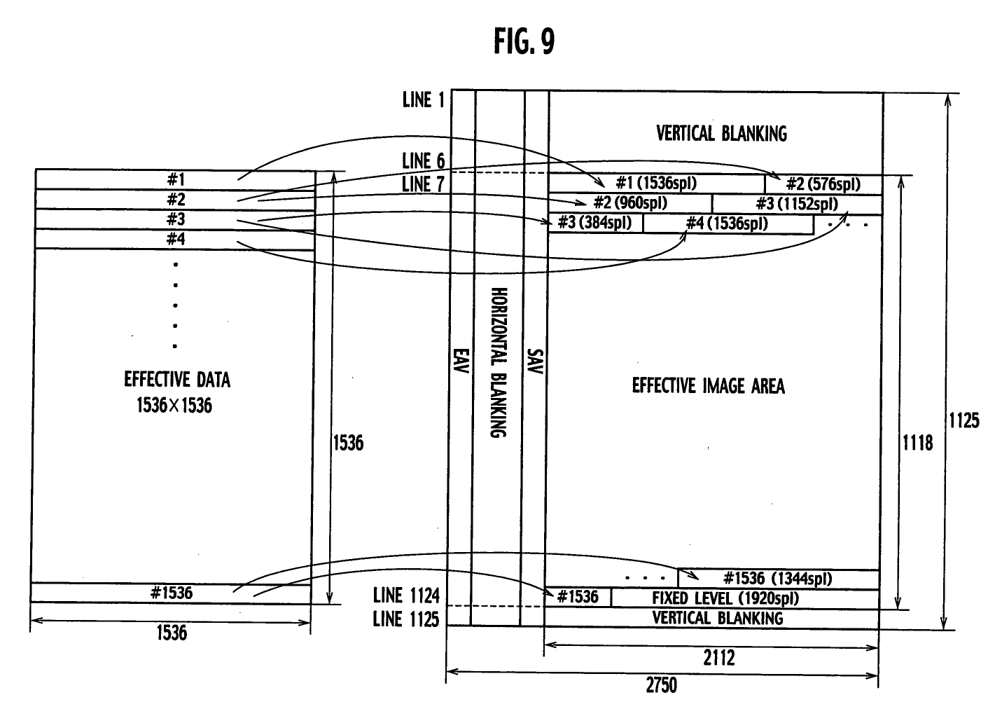

Thus, as shown in FIG. 9, the encoders 122-1 and 122-2 map 2112(horizontal)×1118(vertical) as an effective area out of the total number of pixels which is 1080×24p. In this case, since 2112(horizontal)×1118(vertical) which is the number of pixels of the effective image area is larger than 1536×1536, the mapping is carried out by filling the effective image area with data rows #1, #2, . . . corresponding to scanning lines of 1536(vertical) sequentially from the head address of the effective image area. If the mapping is carried out by filling the area with the data without any space, a blank of 1920 pixels is formed as a fraction at a last 1118-th line. Here, a fixed level (“040h” of a pedestal level or the like) is inserted as shown in FIG. 9. Additionally, SAV codes, EAV codes, a blanking period and the like, are added to create video data for transmission.

Then, the encoders 122-1 and 122-2 serialize the video data for transmission, each consisting of 2×10 bits and two channels, to transmit the data through the transmission lines 13 and 14 of the SMPTE292M standard.

In the reception system 220, the original video data is restored in reverse order to that in the transmission system 120. The decoders 211-1 and 211-2 first decode the transmitted video data to video data for transmission, each consisting of 2×10 bits and two channels. Then, the decoders map the decoded data into the effective image area of 2112(horizontal)×1118(vertical) as shown in FIG. 9, cut out the data row for every 1536 pixels, and remove the SAV codes, EAV codes, the blanking period and the like, to take the data out as the video data of, each consisting of 10 bits and 4-channel, similar to that shown in the lower part of FIG. 6.

The data conversion section 222 allocates the taken-out video data of three pixels to data of a 4:4:4 format of four pixels to restore the original 10-bit and 3-channel video data of the 4:4:4 format (original video data) similar to that shown in the upper part of FIG. 6.

If the numbers of pixels are equal, and a frame frequency is 25 Hz, mapping is carried out to a standard HDTV signal (i.e., 1080/25p) of a frame frequency 25 Hz. In this case, the total number of pixels including horizontal blanking on a right part of FIG. 9 is not 2750 but 2640. Except for this, the method can be realized by completely the same method as that described above.

Additionally, if the numbers of pixels are equal, and a frame frequency is 30 Hz, mapping is carried out to a standard HDTV signal (i.e., 1080/30p) of a frame frequency 30 Hz. In this case, the total number of pixels including horizontal blanking on the right part of FIG. 9 is not 2750 but 2200. Except for this, the method can be realized by completely the same method as that described above.

Furthermore, the number of pixels of the effective area is not limited to 2112(horizontal)×1118(vertical). Requirements are H (the number of horizontal effective pixels) and V (the number of vertical effective pixels) which satisfy 1536×1536 (2048×1536/4)≦H×V, H≦2188 (in the case of 30 Hz), and V≦1125. Here, 2188 is a value obtained by subtracting the EAV, the SAV, a line number (LN) and a cycle redundancy code from the total number of horizontal pixels which is 2200.

Thus, according to the third embodiment, even the video data with the number of effective pixels set to 2048(horizontal)×1536(vertical) can be transmitted through the existing transmission lines of the two systems of the SMPTE292M standard.

[Fourth Embodiment]

In a fourth embodiment, a case in which a transmission line of SMPTE292M transmission standard is used for transmitting video data, constituted of 2048 horizontal effective pixels and 1536 vertical effective pixels as a graphics format of RGB 4:4:4 and of which a frame frequency is 60 Hz will be described.

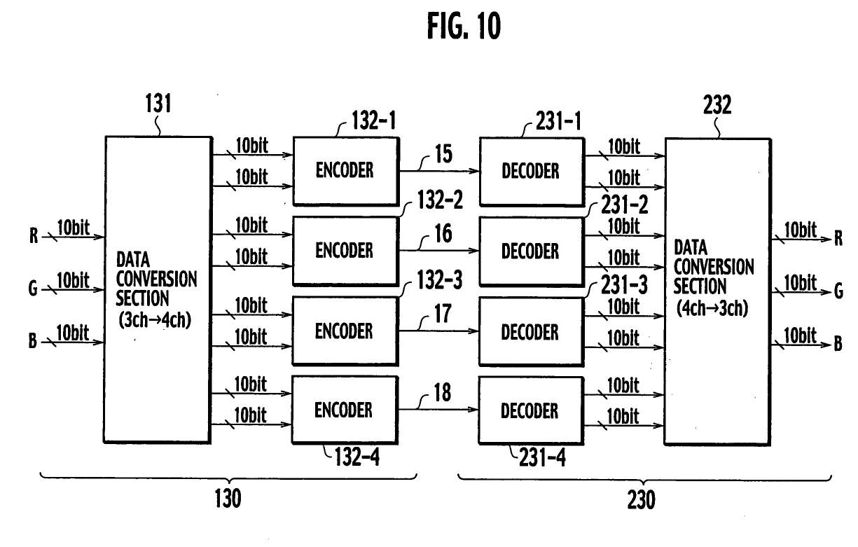

FIG. 10 is a block diagram showing a configuration of a circuit for performing a video data transmitting/receiving method of the fourth embodiment.

As shown in FIG. 10, a transmission system 130 disposed at an output stage of a transmission side includes a data conversion section 131 and encoders 132-1, 132-2, 132-3 and 132-4. A reception system 230 disposed at an input stage of a reception side includes decoders 231-1, 231-2, 231-3 and 231-4, and a data conversion section 232. The encoder 132-1 and the decoder 231-1 are connected to each other through a transmission line 15 of the SMPTE292M transmission standard. The encoder 132-2 and the decoder 231-2 are connected to each other through a transmission line 16 of the SMPTE292M transmission standard. Further, the encoder 132-3 and the decoder 231-3 are connected to each other through a transmission line 17 of the SMPTE 292M transmission standard. The encoder 132-4 and the decoder 231-4 are connected to each other through a transmission line 18 of the SMPTE292M transmission standard.

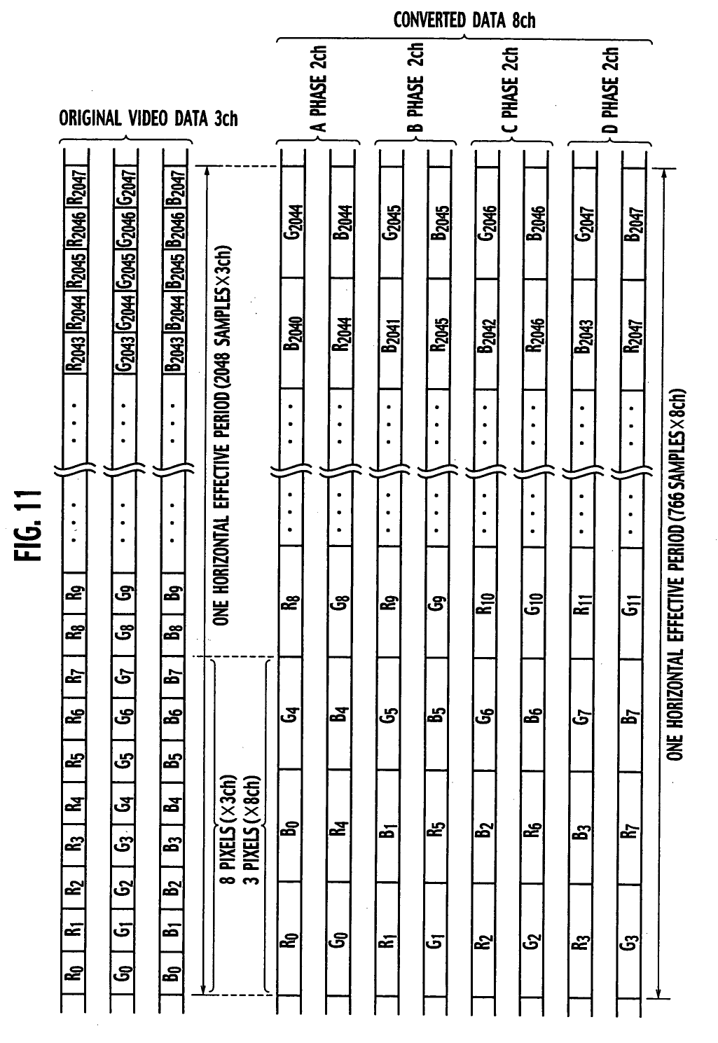

In the transmission system 130, original video data as shown in an upper part of FIG. 11 is inputted to the data conversion section 131 same as in the case of the second embodiment. This original video data is 3-channel video data constituted of RGB signals of 10 bits in a 4:4:4 format. According to the present embodiment, however, a standard HDTV signal (i.e., 1080/60i) of a field frequency 60 Hz of an interlacing system is used. In this case, the total number of lines per field is 1125/2, and the data cannot be transmitted through transmission lines of two systems of the SMPTE292M transmission standard similar to those of the third embodiment. Accordingly, the original video data of eight pixels are allocated to data of a 4:2:2 format of three pixels which is an existing standard HDTV signal to convert the data into 8-channel video data of A, B, C, and D phases (2 channels each) as shown in a lower part of FIG. 11. Thus, the 3-channel video data of 2048 horizontal effective pixels in the RGB 4:4:4 format is converted into the 8-channel video data of 768 horizontal effective pixels.

If this video data is serialized to be transmitted, it becomes 768(horizontal)×1536(vertical)×60(Hz)×10(bits)×8(channels)=about 5.662 Gbps. Thus, in order to serialize and transmit the video data at a transmission speed of 1.485 Gbps equal to that of the SMPTE292M standard, the 8 channels are divided into four each including two channels, and the video data is transmitted through the four transmission lines 15 to 18.

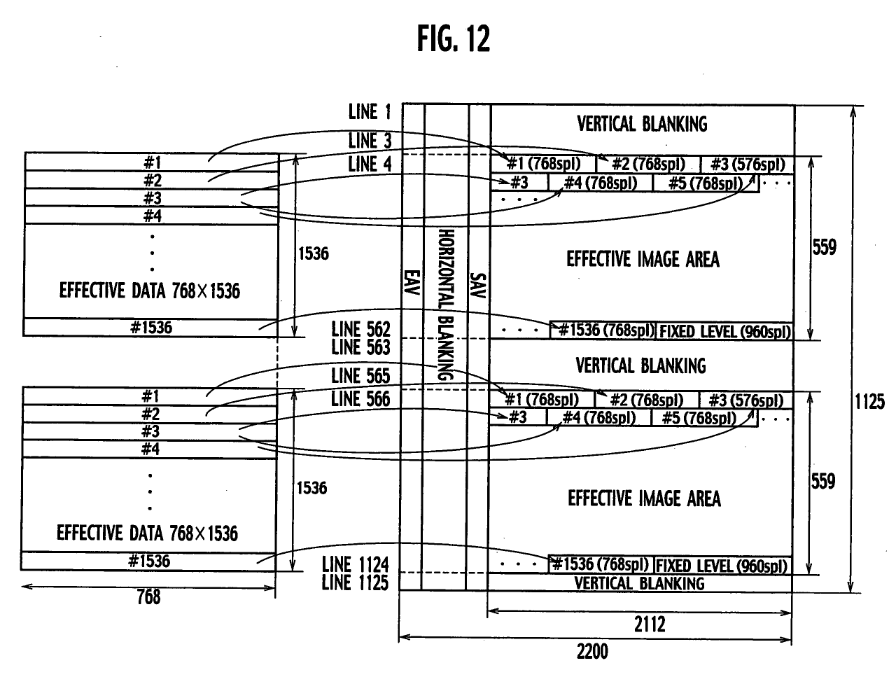

At the encoders 132-1 to 132-4, 768×1536 data is subjected to mapping for the 1080/60i format as shown in FIG. 12. That is, since the data is defined in a frame structure in the 1080/60i format of the SMPTE274M standard, effective image areas of 2112(horizontal)×559(vertical) lines are formed in first and second fields, respectively, and data of 768×1536 is mapped in these areas. In this case, the mapping is carried out by filling the effective image area with data rows of #1, #2, . . . corresponding to scanning lines of 1536(vertical) sequentially from the head address of the effective image area. Additionally, in this case, a blank of 1920 pixels is formed as a fraction at the last 1118-th line. Here, a fixed level (“040h” of a pedestal level or the like) is inserted as in the case of the third embodiment.

The encoders 132-1 to 132-4 serialize the transmission video data of 2×10 bits and four channels which has been mapped as shown in a right part of FIG. 12 to transmit the data through the transmission lines 15 to 18 of the SMPTE292M standard.

In the reception system 230, the original video data is restored in reverse order to that in the transmission system 130. The decoders 231-1 to 231-4 first decode the transmitted data to be transmission video data of 2×10 bits and four channels, then map the decoded data in the effective image area of 2112(horizontal)×559(vertical) as shown in FIG. 12, cut out a data row from each area for every 1536 pixels, and remove the SAV codes, EAV codes, the blanking period and the like, to take the data out as video data of 2×10 bits and 8-channel similar to that shown in the lower part of FIG. 11.

The data conversion section 232 allocates the taken-out video data of three pixels to data of a 4:4:4 format of four pixels to restore the original 10-bit and 3-channel video data of the 4:4:4 format (original video data) similar to that shown in the upper part of FIG. 11.

Incidentally, if the numbers of pixels are equal, and a frame frequency is of 50 Hz or 48 Hz, mapping is carried out to a standard HDTV signal (i.e., 1080/50i, 1080/24sf) of a field frequency 50 Hz or 48 Hz. In this case, the total number of pixels including a horizontal blanking period on a right part of FIG. 12 is not 2200 but 2640 in the case of 50 Hz, and 2750 in the case of 48 Hz. Others can be realized by completely the same method.

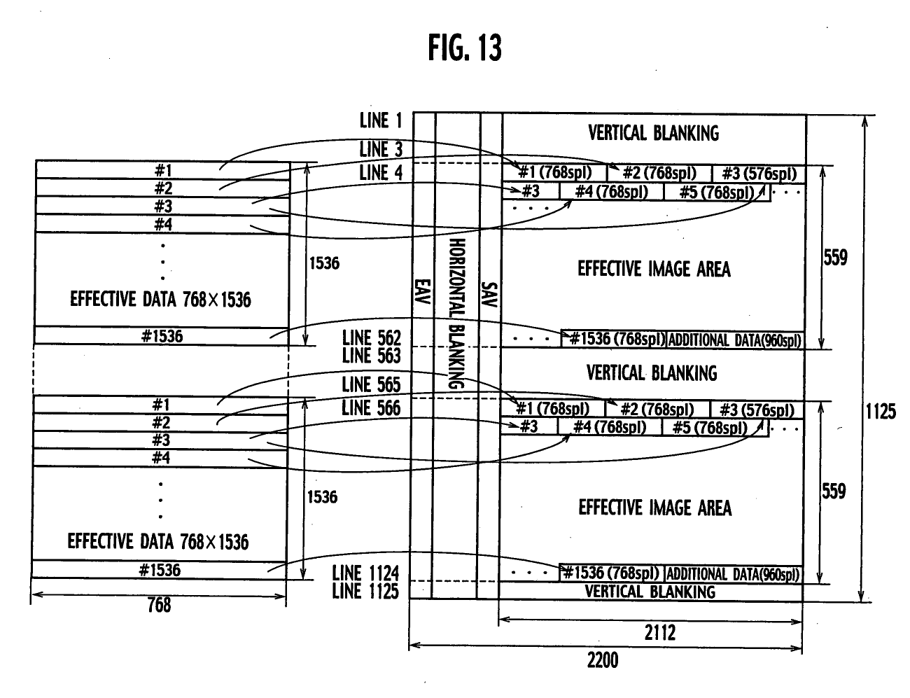

The third and fourth embodiments have been described by exemplifying a case in which the fixed level is inserted into the blank portion of 1920 pixels generated at the last 1118-th line if the mapping is carried out by filling the effective image area with the data rows #1, #2, . . . corresponding to the scanning lines of 1536(vertical) sequentially from the head address of the effective image area. However, additional data for controlling the display device may be inserted into the blank portion. The additional data may be information regarding video contents such as color management data, e.g., a color temperature, a chromaticity point and the like. The insertion of such additional data enables automatic execution of color management in accordance with video contents even if the reproducing device such as a projector (including the transmission system) and a display device (including the reception system) are apart from each other. An example of inserting the additional data in place of the fixed level in the fourth embodiment is shown in FIG. 13.

Additionally, identification data of transmission lines of a plurality of systems can be used as the additional data. The addition of such identification data enables prevention of mistaken cable connection by the user. In this case, the display device of the reception side which has received the identification data may take measures to display a message indicating mistaken connection, to automatically replace the data to reproduce an accurate image, or the like. However, data of “000h” to “003h”, and “3FCh” to “3FFh” inhibited from being transmitted in the SMPTE292M are not used for the additional data.

The first to fourth embodiments show the video data of the RGB 4:4:4 format. However, the invention can be applied to video data of a Y, Pr, Pb (or Y, R-Y, B-Y) 4:4:4 format. For example, in the upper part of FIG. 3, R, G, and B of the 3-channel data may be replaced by Pr, Y, and Pb, respectively.

Furthermore, according to the first to fourth embodiments, the data mapping is carried out in the encoder or the decoder. However, a constitution may be employed in which mapping sections equipped with memories are arranged before the encoder and after the decoder.

As described above, according to the present invention, even the video data of the RGB 4:4:4 format or the video data of the format noncoincident with the number of pixels of the standard HDTV signal, such as a graphic image displayed by a projector, can be transmitted through the existing transmission line of the SMPTE292M standard. Moreover, even if the video data other than the standard HDTV signal is transmitted, it is not necessary to prepare any dedicated transmission lines, and it is possible to use the encoder and the decoder of the SMPTE292M standard which are currently in wide use. Thus, a digital transmission line can be constituted at low costs.

It should be understood that many modifications and adaptations of the invention will become apparent to those skilled in the art and it is intended to encompass such obvious modifications and changes in the scope of the claims appended hereto.

What is claimed is:

1. A video data transmitting/receiving method which uses a transmission line for transmitting video data constituted of three signals of a 4:2:2 format, comprising:
allocating 3-channel video data of two pixels constituted of three signals of a 4:4:4 format to data of the 4:2:2 format of three pixels to convert the video data into 2-channel video data, mapping the converted video data in an effective image area defined by the 4:2:2 format, and serializing video data obtained by the mapping to transmit the data through the transmission line, on a transmission side; and
taking out the 2-channel video data from the received video data, and allocating the video data of three pixels to data of the 4:4:4 format of two pixels to restore the 3-channel video data constituted of the three signals of the 4:4:4 format on a reception side.

2. A video data transmitting/receiving method according to claim 1,
wherein the video data is transmitted through a plurality of transmission lines if the number of horizontal effective pixels of the video data constituted of the three signals of the 4:4:4 format exceeds ⅔ of the number of horizontal effective pixels of the 3-channel video data constituted of the three signals of the 4:2:2 format, and
the number of transmission lines is set to an integer value obtained by rounding up decimals of a value which is obtained by an expression:
(number of horizontal effective pixels of the video data constituted of the three signals of the 4:4:4 format)÷(number of horizontal effective pixels of the 3-channel video data of the three signals of the 4:2:2 format)×3/2.

3. A video data transmitting/receiving method according to claim 1,
wherein the three signals of the 4:4:4 format and the three signals of the 4:2:2 format are three signals selected from three signals of RGB, three signals of Y, Pr, Pb, and three signals of Y, R-Y, B-Y, respectively.

4. A video data transmitting/receiving method which uses a transmission line for transmitting video data constituted of three signals of a 4:2:2 format, comprising:
allocating 3-channel video data of two pixels constituted of three signals of a 4:4:4 format to data of the 4:2:2 format of three pixels to convert the video data into 2-channel video data, mapping the converted video data in an effective image area defined by the 4:2:2 format in a manner of filling the effective image area with data rows corresponding to scanning lines sequentially from a head address of the effective image area, and serializing video data obtained by the mapping to transmit the data through the transmission line, on a transmission side; and
cutting out a data row from the transmitted video data for each predetermined pixel to take out the 2-channel video data, and allocating the video data of three pixels to data of the 4:4:4 format of two pixels to restore the 3-channel video data constituted of the three signals of the 4:4:4 format on a reception side.

5. A video data transmitting/receiving method according to claim 4,
wherein the video data is transmitted through a plurality of transmission lines if the number of effective pixels of the video data constituted of the three signals of the 4:4:4 format exceeds ⅔ of the number of effective pixels of the 3-channel video data constituted of the three signals of the 4:2:2 format.

6. A video data transmitting/receiving method according to claim 4,
wherein the three signals of the 4:4:4 format and the three signals of the 4:2:2 format are three signals selected from three signals of RGB, three signals of Y, Pr, Pb, and three signals of Y, R-Y, B-Y, respectively.
